(19) United States
(12) Patent Application Publication
(10) Pub. No.: US 2012/0058265 A1
(43) Pub. Date: Mar. 8, 2012

(54) CASCADE-TYPE COATING DEVICE FOR POWDERY MATERIAL AND ASSOCIATED METHOD

(75) Inventors: Heinz MEIER, Zurich (CH); Christian Bürge, Schafisheim (CH); Beat Schnider, Luzern (CH)

(73) Assignee: Sika Technology AG, Baar (CH)

(21) Appl. No.: 13/236,244

(22) Filed: Sep. 19, 2011

Related U.S. Application Data
(63) Continuation of application No. PCT/EP2010/053584, filed on Mar. 19, 2010.

(30) Foreign Application Priority Data
Mar. 19, 2009 (EP) 09155601.9

(51) Int. Cl. B05D 1/02; B05B 15/00; B05D 7/00; B05B 1/02

(52) U.S. Cl. 427/212; 118/324; 118/712; 118/612; 118/323

(57) ABSTRACT

A device for coating powdery material with at least one liquid additive. Said device includes an introduction device which includes a supply line and at least two nozzles which can introduce the liquid additive onto the conveyor line and to the powdery material. Said outlet openings of the at least two nozzles are housed at a distance of between 0.5-10 m on the supply line. Also disclosed are a method for coating powdery material with at least one liquid additive and the use of a device for coating powdery material with at least one liquid additive.

### RELATED APPLICATIONS

This application claims priority as a continuation application under 35 U.S.C. §120 to PCT/EP2010/053584, which was filed as an International Application on Mar. 19, 2010 designating the U.S., and which claims priority to European Application No. 09155601.9 filed in Europe on Mar. 19, 2009. The entire contents of these applications are hereby incorporated by reference in their entireties.

### FIELD

The disclosure relates to a device for treating, for example coating, powdery material with at least one liquid additive. Said device comprises a conveying device including at least one conveyor line through which the powdery material is conveyed, and at least one introduction device for introducing the liquid additive onto the at least one conveyor line.

The disclosure also relates to a method for treating powdery material with at least one liquid additive and to the use of a device for treating powdery material with at least one liquid additive.

### BACKGROUND INFORMATION

Cement material is usually extracted from cement clinker. Cement clinker, the preproduct from the cement rotary kiln, is ground to cement powder, then mixed with plaster, which functions as a quick-setting agent, with cement being created as the end product via the mixing process. The cement extracted is stored in silos following production. In subsequent processing into concrete, the cement material is mixed with aggregates, chemical additives and water. Admixing additives is meant to improve concrete characteristics in a chemical and/or a physical respect. In this manner additives are capable, for example, of influencing the flow characteristic, the viscosity, the compaction behavior and the setting behavior of said concrete.

Admixing liquid additive during subsequent processing, for example during conveying, is difficult as the powdery materials required for producing concrete, for example their dust, may react with the liquid additive and affect the conveying of said powdery material by contamination of the conveying device. This can arise for example where an overly large amount of additives is admixed locally or the additive contaminates the conveying device, which may result in blockage and failed conveying of the powdery material.

The reaction of the powdery materials, for example their dust, with the liquid additive can further affect the introduction of the liquid additive by contamination of the introduction device.

High dust concentrations and/or high temperatures can exist, for example, when the powdery materials required for producing concrete are conveyed pneumatically or in pneumatic conveying ducts, which can be conducive to formation of the above-mentioned contaminations.

A reliable and controllable introduction of the liquid additive and a homogeneous distribution of the liquid additive on the powdery material can be beneficial for the quality of the final product and a failure-free course of the treatment process.

### SUMMARY

According to an exemplary aspect, a device for treating or coating a powdery material with at least one liquid additive is provided comprising:
a conveying device including at least one conveyor line through which the powdery material is conveyed; and
at least one introduction device for introducing the liquid additive into the at least one conveyor line comprising the powdery material,
wherein the introduction device comprises a supply line and at least two nozzles which can introduce the liquid additive onto the conveyor line and to the powdery material,
wherein the outlet openings of the at least two nozzles are housed at a distance of 0.5 to 10 m, measured in the conveying direction of the powdery material on the conveyor line.

According to an exemplary aspect, a method for treating or coating powdery material with at least one liquid additive is provided, comprising contacting a liquid additive with a powdery material using a device, wherein the device comprises:
a conveying device including at least one conveyor line through which the powdery material is conveyed; and
at least one introduction device for introducing the liquid additive into the at least one conveyor line comprising the powdery material,
wherein the introduction device comprises a supply line and at least two nozzles which can introduce the liquid additive onto the conveyor line and to the powdery material,
wherein the outlet openings of the at least two nozzles are housed at a distance of 0.5 to 10 m, measured in the conveying direction of the powdery material on the conveyor line.

### BRIEF DESCRIPTION OF THE DRAWINGS

Exemplary embodiments of the disclosure will be illustrated in more detail in the drawings below. Like reference numerals indicate like elements in the different figures. The media flow direction is shown by arrows.

FIG. 1 illustrates a schematic diagram of an exemplary embodiment;

FIG. 2 illustrates a schematic diagram of a top view of exemplary positions of impact areas of a liquid additive;

FIG. 3a and FIG. 3b are diagrams of an exemplary mixing device;

FIG. 4 is another schematic diagram of an exemplary embodiment.

### DETAILED DESCRIPTION

According to an exemplary embodiment, disclosed is a device for providing a controlled, reliable and constant treatment of the powdery material with a liquid additive.

The introduction device 6 of said device 1 comprises a supply line 7 and at least two nozzles 8 which can introduce the liquid additive 3 onto the conveyor line 5 and to the powdery material 2, wherein said outlet openings 9 of the at least two nozzles 8 are housed at a distance of, for example, 0.5 to 10 m, for example 1 to 5 m, measured in the conveying direction of the powdery material 2, on the conveyor line 5.

Exemplary aspects of the disclosure are, inter alia, that a local oversaturation with liquid additive 3 in the conveyor line 5 can be prevented by the arrangement of outlet openings 9 of the at least two nozzles 8 at a distance of 0.5 to 10 m. It can enable, inter alia, distribution of the conveying capacity of the liquid additive among several nozzles 8, and adding liquid additive can be distributed over a larger area in the conveyor line via the distance of said outlet openings 9.

Said device 1 can include a device 10 for determining the flow rate Fl_{FZ} of the liquid additive 3 and a device 11 for determining the conveying pressure P_{FZ} of the liquid additive 3 and, if required or desired, a device 12 for determining the flow rate Fl_{PM} of the powdery material 2. An increased conveying pressure P_{FZ} can, for example, indicate blockage in the introduction device 6 or alternatively an increased flow rate Fl_{Fz}, which is caused by an increased flow rate Fl_{PM} of the powdery material 2.

If a defined upper conveying pressure P_{FZ O} as opposed to normal or optimal operation is reached, another nozzle 8 can be connected (cascade) so that subsequently said conveying pressure P_{Fz} due to the larger outlet area falls back again into the normal value range P_{Fz opt} and the spray image remains in a safe range. In an exemplary embodiment, this means, inter alia, that for example a deliberate flat jet does not exit as a concentrated jet or uncontrolled spray image. Vice versa, for example, a decreased conveying pressure P_{Fz} has an analogous effect. By conveying a liquid additive within a normal value range P_{FZ opt}, for example, the nozzle, for example if it is a flat-jet nozzle, includes a pressure area or flow-through area respectively in which an optimal spray image is ensured. Outside P_{FZ opt}, for example, the conveying device or the nozzles can be contaminated or the conveyor line 5 can become oversaturated locally with liquid additive 3. For example, this would not be conducive to a controllable introduction of liquid additive and a homogeneous distribution of the liquid additive on the powdery material.

Admixing the liquid additive 3 alone, based on a determination of the flow rate Fl_{FZ} of the liquid additive (more flow-through can require more open nozzles), may also be envisaged. It would, for example, allow neither for an increased pressure in the event of blockage nor for conveying of the nozzles in an exemplary pressure range. In addition, the conveying pressure P_{FZ} might increase so much that the introduction device would be damaged and treatment of the powdery material with liquid additive would be stopped.

Said device 1 can comprise at least one mixing device 14, which thoroughly mixes the mixture of powdery material 2 and liquid additive 3. This can result in the homogeneous distribution of the liquid additive on the powdery material. If the mixing device 14 moves the powdery material 2 actively in the conveying direction of the powdery material 2, for example blockage of the conveyor line 5 can be prevented or dissolved respectively.

At least one of said nozzles 8 can be movable around, for example rotatable towards, the axis of the exit direction of the liquid additive 3. On the one hand, the spray image can be adjusted to the flow rate Fl_{Fz} and/or the conveying pressure P_{Fz}, for example the conveying pressure P_{FZ}, of said liquid additive 3 if the nozzle is rotated towards the axis of the exit direction, for example if it is a nozzle with a spray image including an elliptic or rectangular impact area 16.

The at least one nozzle 8 can, for example, also be disposed movably into and out of the conveyor line 5. For example, it is, inter alia, conducive to prevention of contaminations of the nozzle 8 in that the nozzles, for example the outlet opening 9, are protected from said dust 17 of the powdery material 2. It also can enable the nozzles to be cleaned outside the conveyor line 5 by a cleaning device 18, which can improve the constructive design of the cleaning environment. Further, any nozzles that are consequently not used can be protected from said dust 17 outside the conveyor line. Either variant can increase the flexibility of said device 1 compared with the amount and viscosity of the liquid additive 3.

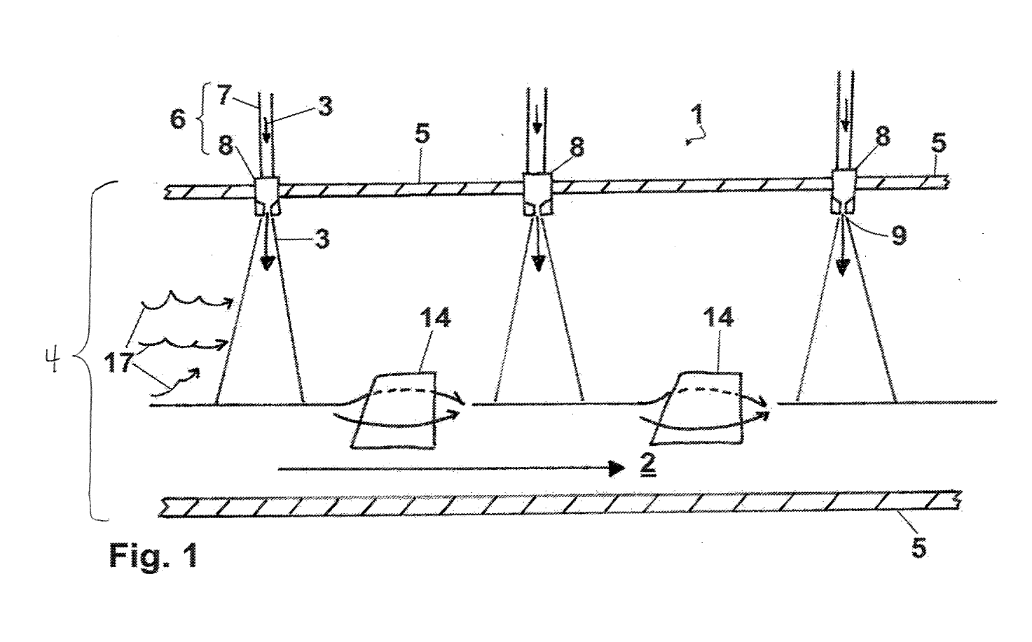

In FIG. 1 the schematic assembly of an exemplary device 1 for treating, for example coating, powdery material 2 with at least one liquid additive 3 is shown. Said device 1 comprises at least one conveying device 4 including at least one conveyor line 5 through which the powdery material 2 is conveyed, and at least one introduction device 6 for introducing the liquid additive 3 onto the at least one conveyor line comprising the powdery material 2. The introduction device 6 comprises a supply line 5 and at least two nozzles 8 which can introduce the liquid additive 3 onto the conveyor line 5 and to the powdery material 2, wherein said outlet openings 9 of the at least two nozzles 8 are housed at a distance of 0.5 to 10 m, for example 1 to 5 m, measured in the conveying direction of the powdery material 2 on the conveyor line 5.

The device can comprise at least three nozzles 8. The device can ensure treatment of powdery material 2 with at least one liquid additive 3 in a larger area of flow rate Fl_{Fz} through at least two, for example at least three nozzles. In this document “powdery material” is understood as a material which is obtained through disaggregation of a dry solid substance, for example via chopping, pulverizing, pounding or grinding in mills or via spray drying.

Powdery materials can be classified roughly according to grain size; powdery materials can be classified, for example, via their bulk density and via sieve analysis. Powdery materials can have a flow behavior reminiscent of liquids, for example during pneumatic transport. Powdery materials 2 can have a particle size of about 1-200 μm, for example 3-30 μm, and/or a fineness according to Blaine of 2000-8000 cm²/g, for example 3000-6000 cm²/g.

Non-hydraulic, hydraulic and latently hydraulic powdery materials of any type, for example of the type required or employed in large amounts for the construction industry, are suitable as powdery material 2.

Further materials suitable as powdery materials 2 are substances which are used to produce concrete, mortar or plaster, for example cement particles. It is also possible to use substances or additives such as for example silica fume, fly ash, lightweight aggregate, scoria, fiber materials, for example organic ones such as polypropylene fibers etc. or inorganic ones such as basalt, glass etc.

It is possible to treat, for example coat, all substances which are used to produce concrete, mortar or plaster, with a liquid additive 3. Powdery material can be coated where said powdery materials are conveyed pneumatically. That means the treatment process does not necessarily have to occur during concrete, mortar or plaster production. The base substances can hence already be treated at the place of their production. Consequently, the cement particles can for example be treated directly at the end of the cement production process.

The powdery material 2 can comprise at least one bonding agent, which for example is selected from the group consisting of cement, mortar, plaster, silica fume, fly ash, scoria and granulated cinder or a mixture thereof.

The powdery material 2 can be cement.

Suitable liquid additives 3 can include materials which can be dispersed and/or sputtered and/or vaporized and which have a viscosity of 1-500 mPa*s.

Some liquid additives, whose names in most cases will reveal their effect, will be listed by way of example and without limitation: plasticizer, superplasticizer, air entrainer, (reaction) retarding agent, accelerator such as setting and hardening accelerator, stabilizer, chromate reducer, grouting aids, foaming agent, air-entraining agent, densifier, corrosion inhibitor and recycling aids.

The at least one liquid additive 3 can be selected from the group consisting of dispersing agent, fluidifier, superplasticizer, retarding agent, accelerator, stabilizer, shrinkage reducer, air-entraining agent and corrosion inhibitor or a mixture thereof.

A high-performance concrete plasticizer can be used as liquid additive, for example, the product ViscoCrete® of the company Sika. This high-performance concrete plasticizer can reduce the amount of water required by cement, improving concrete processability.

The conveying device 4, which includes at least one conveyor line 5, through which the powdery material 2 is conveyed, can be a conveying device in the construction industry.

Such a conveying device 4 for example can serve the purpose of transport from production of the powdery material 2 to an interim storage facility, such as an interim silo, to a mobile means of transport, such as for example a lorry or rail carriage, or a final storage facility. Transport of the powdery material 2 in a conveyor line 5 can be effected by means of bucket conveyors, belt conveyors, pneumatically or in so-called pneumatic conveyor ducts, also referred to as “air slides”. Exemplary pneumatic conveyor ducts are, for example, commercially available at the company Mahr GmbH, Germany. Pneumatic conveyor ducts can include rectangular steel pipes having a width of 10-100 cm and a height of 10-100 cm, the powdery material 2 while being conveyed in them has a filling height of typically ¼-¾ of the range intended for the powdery material. Moving the powdery material 2 in a pneumatic conveyor duct can be based on fluidization of the powdery material by means of air as well as slanting of the duct from 5 to 10°, which together with the kinetic energy bringing along the powdery material upon entry into the pneumatic conveyor duct, enables the powdery material to move.

Fluidization can occur by making air pass through from below through the powdery material located on a perforated bottom surface, whereby the particles of the powdery material continue moving up and down within an emerging fluidized bed, thus effectively remaining suspended.

Separation of fluidization air and the powdery material can be effected via a separation mesh of plastic or glass fibers, with the fluidization air being able to pass the mesh, yet not the powdery material 2 to be conveyed.

In the conveyor line 5 temperatures of up to 120° C. can prevail, in addition dust 17 can form from powdery material above said powdery material 2.

In the present document the term “dust” is understood as the unwanted dispersed diffusions of solid substances, for example of powdery material 2, in gases, formed by mechanical processes or by lifting of particles, for example by transport in the conveyor line 5, with the solid substance being dispersed into the ambient air within the conveyor line 5.

For example, the conveyor line 5 is a pneumatic conveyor duct. Said powdery material 2 can be transported at a constant speed of about 0.5-10 m/s through the conveyor line 5.

Said introduction device 6 for introducing the liquid additive 3 into the at least one conveyor line 5 comprises a supply line 7 and at least two nozzles 8. The liquid additive 3 can be introduced into the conveyor line 5 and to the powdery material 2 via at least one nozzle.

The liquid additive 3, for example, can be dispersed (aerosol) and/or sputtered (drops) and/or vaporized (vapor). The coating thickness of the powdery material can be set by means of the varying consistencies using the liquid additive.

The liquid additive 3 can be conveyed to the at least two nozzles 8 via the supply line 7 at a pressure of 1-15 bar, for example 3-7 bar. The pressure of the supply line can be larger or equal, for example larger than the rated pressure of the nozzles. The introduction device 6 can include a pump for conveying the liquid additive 3 as well as at least one valve 19 in front of at least one nozzle 8. The supply line 7 can include a main supply line 71 as well as ancillary supply lines 72, which connect the main supply line 71 with the nozzles 8.

Suitable nozzles 8 inter alia allow for spraying of the liquid additive 3 at pressures of 1-30 bar, for example 3-7 bar. Said nozzles can be flat-jet nozzles, fog nozzles or two-phase nozzles, for example flat-jet nozzles.

Fog nozzles can atomize pressurized liquids into extremely fine drops with a large specific surface.

Two-phase nozzles can be marked by very fine atomization in that liquids are mixed with air or gas. Further, they can produce various spray images, such as for example flat jet, hollow cone or full cone spray images.

Flat-jet nozzles can be marked by even liquid or pressure distribution. Further, they can allow for large variability in the spray angle selection. Suitable nozzles can have a spray angle of 30°-120°. Depending on the design of the outlet opening 9 of the nozzle, an elliptic or a rectangular impact area 16 is feasible. Flat-jet nozzles are inexpensive and, due to a defined and well-controllable impact area 16, allow for targeted treatment of the powdery material 2 with the liquid additive 3. For example, contact between the liquid additive 3 and the conveyor line 5, for example the walls and, in case of a pneumatic conveyor duct, the separation mesh, can be avoided. This reduces the risk that conveying of the powdery material 2 might be blocked in that either fluidization of the powdery material 2 is reduced or the powdery material becomes fixed to the walls or agglomerates.

The at least two nozzles 8 typically can have a nozzle bore of 0.1-1 mm.

The nozzles 8 can be arranged on the conveyor line 5 such that the liquid additive 3 may be brought into contact as evenly as possible with as large a portion of the powdery material 2 as possible. The nozzles can be arranged on the conveyor line wall opposite to the powdery material 2. The nozzles, for example the outlet opening 9, can be located in as great a distance from the powdery material 2 as possible in the conveyor line 5. This, on the one hand, allows for greater flexibility in the treatment with the liquid additive 3; on the other hand, the nozzles thus are less exposed to dust 17 of the powdery material 2, which thereby reduces the likelihood of contamination of the nozzles.

The distance between the outlet opening 9 of the nozzle 8 and the powdery material 2 can depend on the filling height of the powdery material 2, the shape of the cross section of the conveyor line and the spray angle of the nozzle.

The outlet opening 9 does not necessarily have to be disk-shaped, but can have other cross section geometries; it may be formed, for example, as an elongated slit, whose length is a multiple of its height. The exit direction of the liquid additive 3 exiting the nozzle does not necessarily have to be identical with the nozzle axis direction.

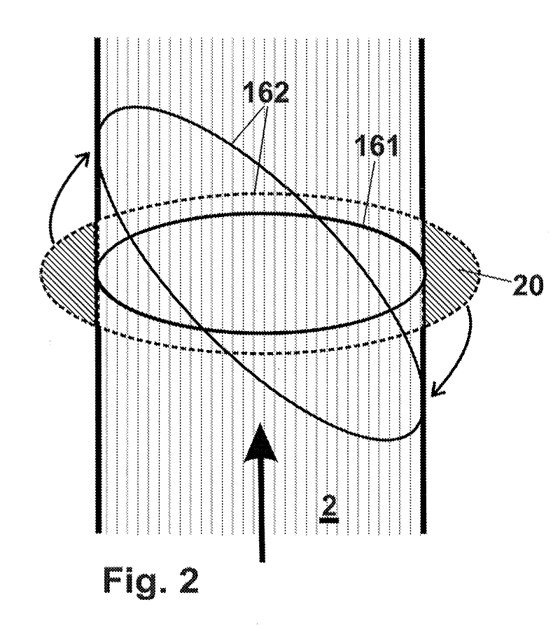

At least one of said nozzles 8 can be movable, for example rotatable, around the axis of the exit direction of the liquid additive 3. On the one hand, the spray image can be adjusted to flow rate Fl_{Fz} and/or conveying pressure P_{Fz} of the liquid additive 3 when the nozzle is rotated around the axis of the exit direction, for example if it is a nozzle with a spray image including an elliptic or rectangular impact area 16. This is illustrated schematically in FIG. 2. FIG. 2 is a top view of the powdery material 2, which is transported in the conveyor line 5, showing exemplary positions of impact areas 16. For example, if said impact area 16 of the smaller impact area 161 is enlarged, for example by an increase of flow rate Fl_{Fz} and/or conveying pressure P_{Fz}, then spraying on the exterior 20 can be prevented by the larger impact area 162 in that the nozzle is rotated around the axis of the exit direction. As a result, contamination of the exterior 20, for example the conveyor line 5, for example the walls and, in case of a pneumatic conveyor duct, the separation mesh, can be avoided. Further, as a result, liquid additive 3 can be added over a larger area of the conveyor line in a distributed manner. For example, rotatability of the at least one nozzle around the axis of the exit direction of the liquid additive 3 can be controlled via a control system 13.

At least one of the at least two nozzles can convey the liquid additive 3 into the conveyor line 5 and to the powdery material 2. For example, said device 1 includes at least two nozzles in normal operation, the nozzles conveying the liquid additive 3 into the conveyor line 5, and a nozzle which does not convey any liquid additive. Said device 1 can respond accordingly both when a defined upper conveying pressure P_{FZ O} compared to normal or optimal operation is reached and when the conveying pressure P_{FZ} decreases, and ensure conveying in the normal value range P_{FZ opt}.

The at least one nozzle 8 can also be disposed movably into and out of the conveyor line 5. It can be conducive to prevention of contaminations of the nozzle 8 in that the nozzles, for example the outlet opening 9, are protected from said dust 17 of said powdery material 2. It also can enable nozzles to be cleaned outside the conveyor line 5 by a cleaning device 18, which improves the cleaning environment. Further, any nozzles that are consequently not used can be protected from said dust 17 outside the conveyor line. For example, movement of the at least one nozzle into or out of the conveyor line 5 can be controlled via a control system 13.

Movability of the nozzles 8 can allow for greater flexibility of said device 1 with regard to flow rate Fl_{Fz} and conveying pressure P_{FZ}, liquid additives as a result may, for example, be used over a larger viscosity range. Obviously, nozzles can also feature both movabilities, into the conveyor line 5 and out of it as well as rotatable about the axis of the exit direction of the liquid additive 3.

Further, said device 1 can include at least one cleaning device 18 for cleaning the introduction device 6. Said cleaning device 18 may comprise a means for cleaning said introduction device 6, for example, which is selected from the group consisting of sieve, solvent, pressurized air, mechanical tool and ultrasonic sound. Said cleaning device 18 can clean components or the entire introduction device 6 as needed or desired and/or permanently over time or in regular intervals. Said cleaning device 18 can be controlled by a control system 13. Said cleaning device 18 can be arranged within or outside the conveyor line 5. A combination of the means mentioned may also be used.

Said device 1 can comprise at least one mixing device 14, which thoroughly mixes the mixture of powdery material 2 and liquid additive 3.

Suitable mixing devices 14 can include a device which is capable of mixing the powdery material 2 and the liquid additive 3 to produce a common, flowable material flow that has been mixed through completely or partially.

The mixing device 14, at least partially, can be arranged in the conveyor line 5.

The mixing device 14 may be a static mixing device, in which mixing is effected by repeated separation of the material flow 21, and a dynamic mixing device, in which the material flow is divided, or its particles are lifted, several times by means of a moving element. In the present document the term “material flow” is understood as powdery material 2 in the conveyor line 5 and in addition, if present, liquid additive 3 in combination with powdery material.

Suitable static mixing devices can include, for example, devices having shaped parts capable of mixing the material flow 21 in the conveyor line 5 by repeated separation, diversion and merging. For example, said shaped parts can be plough share-like mixing tools, their size, arrangement, circumferential speed and geometrical shape being dimensioned and adapted to one another such that they are capable of optimally mixing the material flow 21.

Shaped parts can be spiral- or coil-shaped, which can cause reversed rotation and current sharing, which consequently can ensure good and continuous thorough mixing.

Static mixing devices can require little maintenance, and can decelerate the material flow little and do not necessarily require any external energy.

Suitable mixing devices can include, for example, screw mixers. The screw band design, for example a basic, discontinuous or contradirectional screw band, can provide the material flow 21 with a swirling, three-dimensional movement. Here the powdery material and the liquid additive are brought together by thrust movements along the conveyor line 5 and in the material flow 21 itself.

Further, suitable dynamic mixing devices can include homogenizers located in the conveyor line 5, which operate with pumping effect.

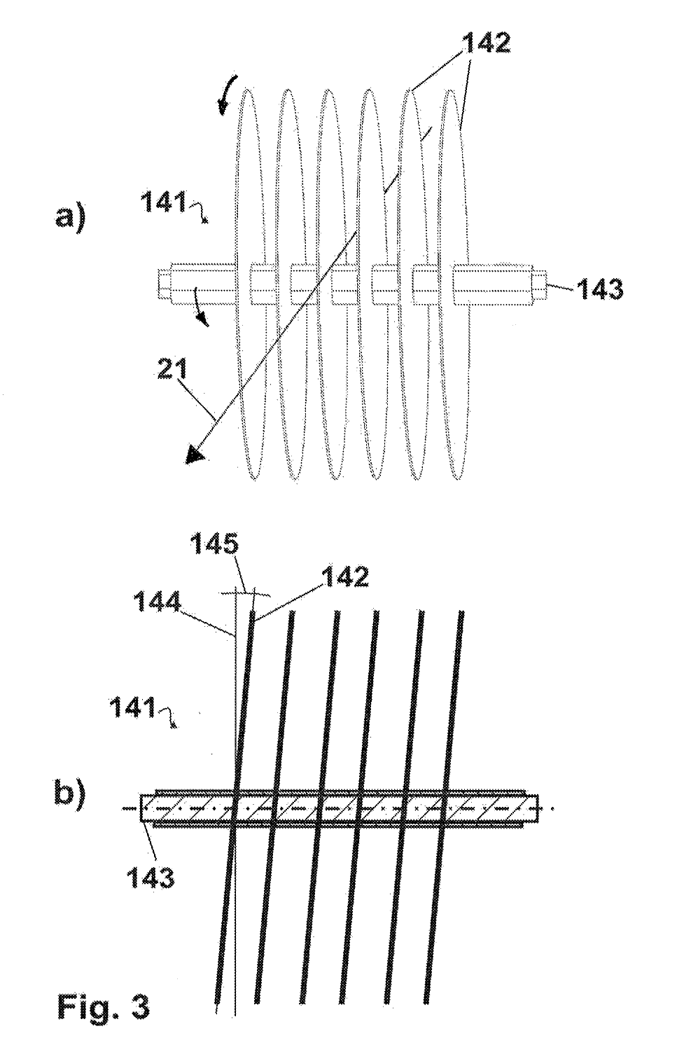

Another exemplary suitable mixing device is a tumbling element 141, as shown in FIGS. 3a and 3b. The tumbling element 141 may be located partially or entirely in the material flow 21. In FIG. 3a the flow direction of the material flow 21 is shown by a straight arrow. The tumbling element typically includes one or more disk-type shaped parts 142, which are connected to the tumbling element axis 143 such that, when the tumbling element axis is rotated, they perform a tumbling movement vertical to the tumbling element axis. The at least one disk-type shaped part can be arranged in a fixed manner on the tumbling axis 143 such that the disk-type shaped part is arranged inclined by 2°-20° opposite the vertical axis 144 of the tumbling element axis. FIG. 3b shows an exemplary inclination 145 of the disk-type shaped part opposite the vertical axis 144 of the tumbling element axis 143. The disk-type shaped parts can be circular plates made of metal. The tumbling element axis can be arranged substantially horizontally to the flow direction of the powdery material 2 in the conveyor line 5. The tumbling movement of the disk-type shaped parts towards the flow direction of the powdery material 2 can ensure good and continuous thorough mixing.

Rotation of the disk-type shaped parts around the tumbling element axis can be sufficiently rapid such that the powdery material 2 when in contact with the disk-type shaped part experiences acceleration towards the conveying direction of the powdery material.

Use of dynamic mixing devices can, in addition to resulting in the mixing process, move the powdery material 2 actively in the conveying direction of the powdery material. For example, this can be exploited for preventing and/or eliminating blockage in the conveyor line, for example by agglomeration of powdery material.

The mixing device 14, for example, can be a mixing device which moves the powdery material 2 actively in the conveying direction of the powdery material 2. For example, the mixing device 14 can be a tumbling element.

The mixing device 14 can be a mechanical or a pneumatic mixing device.

Pneumatic mixing devices can be mixing devices comprising at least one mixing nozzle 15, through which a gas, for example air, can be blown into the mixture of powdery material 2 and liquid additive 3. The gas jet produced by the mixing nozzle 15 can trigger the necessary mixing movements in the material flow 21. Pneumatic mixing devices, for example, can be controlled easily and they do not necessarily include any components that are moved mechanically.

Said device 1 can include a device 10 for determining the flow rate Fl_{FZ} of the liquid additive 3, for example a flow meter, and a device 11 for determining the conveying pressure P_{FZ} of the liquid additive 3, for example a manometer.

Further, said device 1 can include means 12 for determining the flow rate Fl_{PM} of the powdery material 2, for example a flow meter for powdery media.

The flow Fl_{PM} of the powdery material 2 may be determined empirically or technically.

Said device 1 may further comprise at least one control system 13 which as measurement parameter includes the flow rate Fl_{Fz} of the liquid additive 3 and/or the conveying pressure P_{FZ} of the liquid additive and/or the flow rate Fl_{PM} of the powdery material 2.

The control system 13 can include the conveying pressure P_{Fz} of the liquid additive as measurement parameter.

The control system 13 as control variable can connect or disconnect at least one nozzle 8 and/or as control variable can connect or disconnect at least one cleaning device.

The mass ratio of any added liquid additive 3 to powdery material 2 can be 1:10-1:1000, for example 1:100-1:500.

The control system 13 can include a device 10 for determining the flow rate Fl_{FZ} of the liquid additive 3, for example a flow meter, and a device 11 for determining the conveying pressure P_{FZ} of the liquid additive 3, for example a manometer.

Further, the control system 13 can include a device 12 for determining the flow rate Fl_{PM} of the powdery material 2, for example a flow rate for powdery media.

For example, if a maximum conveying pressure P_{Fz max} of the liquid additive 3 is set and conveying of the liquid additive is stopped once the maximum conveying pressure P_{Fz max} is reached, for example by blockage in the main supply line 71, damage to the introduction device 6 can be prevented.

Conveying capacity deviations from the liquid additive 3, for example by contaminations, can be compensated in that the conveying pressure P_{FZ} is changed, for example in combination with a corresponding rotation of the nozzles around the axis of the exit direction of the liquid additive and/or alternatively if nozzles 8 are connected or disconnected.

The control system 13 for example can include use of the cleaning devices 18 and/or use of the mixing devices 14 as control variable. For example, the control system 13 as control variables can include the devices mentioned and rotation of the nozzles around the axis of the exit direction of the liquid additive and connecting or disconnecting of nozzles.

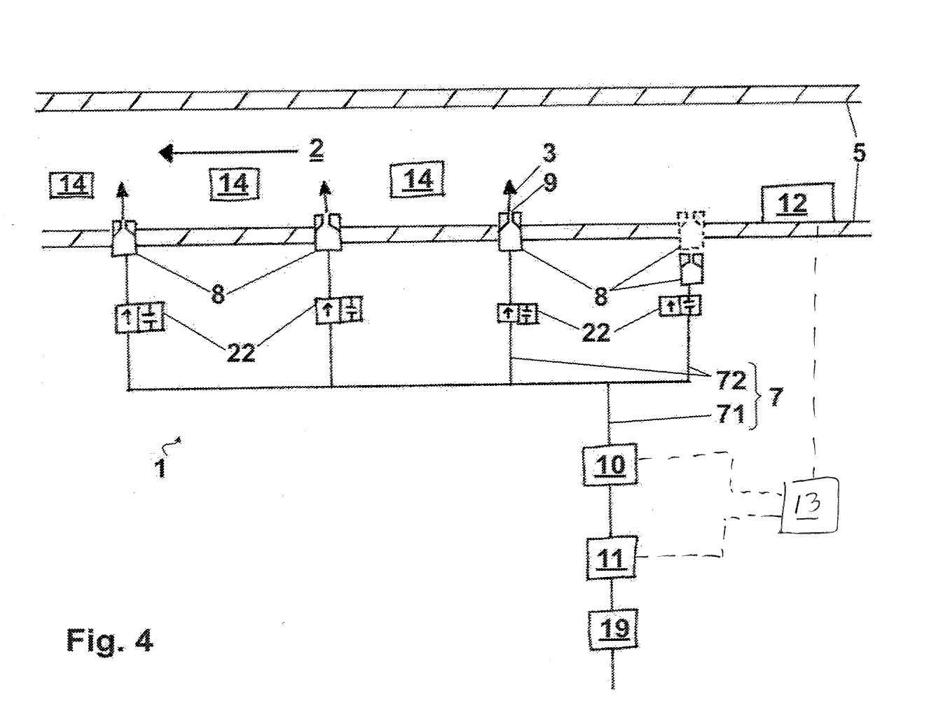

FIG. 4 illustrates schematically an example of a device 1. Powdery material 2 is conveyed through the conveyor line 5 of the conveying device 4, and liquid additive 3 is sprayed onto the conveyor line 5 via the introduction device 6 through nozzles 8. The device 1 further includes a device 12 for determining the flow rate Fl_{PM} of the powdery material 2.

Further, mixing devices 14 are located in the conveyor line 5, which are located at least partially in the material flow 21 of the powdery material. Said mixing devices can be tumbling elements of the above-described type.

The introduction device 6 can comprise, for example, a supply line 7, which can include a main supply line 71 as well as ancillary supply lines 72, and four nozzles 8, of which the exit openings 9 of three nozzles are located in the conveyor line 5 and dispense liquid additive and a nozzle does not convey any liquid additive and is arranged outside the conveyor line 5 as protection from said dust 17. The four nozzles are nozzles which can be moved into and out of the conveyor line 5 and are rotatable around the axis of the exit direction of the liquid additive 3. Both movabilities are control variables of a control system 13.

The device further includes means 10 for determining the flow rate Fl_{FZ} of the liquid additive 3 and of the conveying pressure P_{FZ} 11 of the liquid additive. The ancillary supply lines 72 further include a 1-way valve 22, for example a 1-way valve including two switching positions that can be actuated electrically. Consequently, the control system 13 can switch on or switch off the conveying of individual nozzles.

The disclosure further comprises a method for treating, for example coating, powdery material 2 with at least one liquid additive 3, wherein the liquid additive 3 is brought into contact with the powdery material 2 via a device 1 as described above.

For example, the method comprises the steps of:
a. conveying powdery material 2 through a conveyor line 5;
b. spraying on powdery material 2 with at least one liquid additive 3 in an amount which is proportional to the flow rate Fl_{PM}.

The method can comprise the step of:
c. determining the flow rate Fl_{PM} of the powdery material 2 and/or determining at least one conveying parameter FP_{Fz} of the liquid additive 3, wherein FP_{Fz} comprises the two parameters flow rate Fl_{Fz} of the liquid additive 3 and conveying pressure P_{Fz} of the liquid additive 3.

The method can comprise determining the flow rate Fl_{PM} of the powdery material 2, determining the flow rate Fl_{Fz} of the liquid additive 3 and determining the conveying pressure P_{Fz} of the liquid additive 3.

The method can comprise at least one of the steps of:
d. connecting or disconnecting at least one nozzle 8 through which the powdery material 2 is sprayed with at least one liquid additive 3 if at least one conveying parameter FP_{Fz} of the liquid additive 3 falls below a threshold value FP_{Fz min} or exceeds a threshold value FP_{Fz max}, for example if the conveying pressure P_{Fz} of the liquid additive 3 exceeds a threshold value P_{FZ max}; and/or
e. rotation of at least one nozzle around the axis of the exit direction of the liquid additive 3 if at least one conveying parameter FP_{Fz} of the liquid additive 3 falls below a threshold value FP_{Fz min} or exceeds a threshold value FP_{Fz max}, for example if the conveying pressure P_{Fz} of the liquid additive 3 exceeds a threshold value P_{FZ max}.

The method can comprise at least the step of:
f. thoroughly mixing the mixture of powdery material 2 and liquid additive 3 by a mixing device 14.

The method can comprise at least the step of:
g. switching off conveying of the liquid additive 3 when a maximum conveying pressure P_{Fz max} is reached.

The method can comprise at least the step of:
h. cleaning of parts or the whole introduction device 6 by a cleaning device 18.

According to an exemplary aspect, use of a device 1 of the above-described type for treating, for example coating, powdery material 2 with at least one liquid additive 3 is disclosed.

It is evident that the disclosure is not limited to the exemplary embodiments which have been shown and described.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

1 Device

2 Powdery material

3 Liquid additive

4 Conveying device

5 Conveyor line

6 Introduction device

7 Supply line

71 Main supply line

72 Ancillary supply line

8 Nozzle

9 Outlet opening

10 Device for determining the flow rate Fl_{FZ} of the liquid additive

11 Device for determining the flow rate P_{FZ} of the liquid additive

12 Device for determining the flow rate Fl_{PM} of the powdery material

13 Control system

14 Mixing device

141 Tumbling element

142 Disk-type shaped part

143 Tumbling element axis

144 Vertical axis of the tumbling element axis 143

145 Inclination of the disk-type shaped part towards the vertical axis 144

15 Mixing nozzle

16 Impact area

161 Smaller impact area

162 Larger impact area

17 Dust of the powdery material

18 Cleaning device

19 Valve

20 Exterior impact area

21 Material flow

22 1-way valve

What is claimed is:

1. A device for treating or coating a powdery material with at least one liquid additive comprising:
a conveying device including at least one conveyor line through which the powdery material is conveyed; and
at least one introduction device for introducing the liquid additive into the at least one conveyor line comprising the powdery material,
wherein the introduction device comprises a supply line and at least two nozzles which can introduce the liquid additive onto the conveyor line and to the powdery material,
wherein the outlet openings of the at least two nozzles are housed at a distance of 0.5 to 10 m, measured in the conveying direction of the powdery material on the conveyor line.

2. The device as defined in claim 1, wherein the conveyor line is a pneumatic conveyor duct.

3. The device as defined in claim 1, wherein the device includes a device for determining the flow rate Fl_{FZ} of the liquid additive and a device for determining the conveying pressure P_{FZ} of the liquid additive.

4. The device as defined in claim 1, wherein the device comprises at least one control system which as a measurement parameter includes the flow rate Fl_{Fz} of the liquid additive and/or the conveying pressure P_{FZ} of the liquid additive and/or the flow rate Fl_{PM} of the powdery material.

5. The device as defined in claim 1, wherein the device comprises at least one mixing device, which thoroughly mixes the mixture of powdery material and liquid additive.

6. The device as defined in claim 5, wherein the mixing device moves the powdery material actively in the conveying direction of the powdery material.

7. The device as defined in claim 5, wherein the mixing device is arranged within the conveyor line.

8. The device as defined in claim 7, wherein the mixing device is a tumbling element.

9. The device as defined in claim 5, wherein the mixing device comprises at least one mixing nozzle, through which a gas can be blown into the mixture of powdery material and liquid additive.

10. The device as defined in claim 1, wherein at least one of the nozzles is movable around the axis of the exit direction of the liquid additive.

11. The device as defined in claim 1, wherein the powdery material comprises at least one hydraulic bonding agent.

12. The device as defined in claim 1, wherein the at least one liquid additive is selected from the group consisting of a dispersing agent, fluidifier, superplasticizer, retarding agent, accelerator, stabilizer, shrinkage reducer, air-entraining agent, corrosion inhibitor and a mixture thereof.

13. A method for treating or coating powdery material with at least one liquid additive, comprising contacting a liquid additive with a powdery material using a device, wherein the device comprises:
a conveying device including at least one conveyor line through which the powdery material is conveyed; and
at least one introduction device for introducing the liquid additive into the at least one conveyor line comprising the powdery material,
wherein the introduction device comprises a supply line and at least two nozzles which can introduce the liquid additive onto the conveyor line and to the powdery material,
wherein the outlet openings of the at least two nozzles are housed at a distance of 0.5 to 10 m, measured in the conveying direction of the powdery material on the conveyor line.

14. The method as defined in claim 13, further comprising:
conveying powdery material by the at least one conveyor line; and
spraying the powdery material with at least one liquid additive in an amount which is proportional to the flow rate Fl_{PM} of the powdery material.

15. The method as defined in claim 14, further comprising:
connecting or disconnecting at least one nozzle through which the powdery material is sprayed with at least one liquid additive if at least one conveying parameter FP_{Fz} of the liquid additive falls below a threshold value FP_{Fz min} or exceeds a threshold value FP_{Fz max}; and/or
rotating at least one nozzle around the axis of the exit direction of the liquid additive if at least one conveying parameter FP_{Fz} of the liquid additive falls below a threshold value FP_{Fz min} or exceeds a threshold value FP_{Fz max}.

16. The device as defined in claim 1, wherein the outlet openings of the at least two nozzles are housed at a distance of 1 to 5 m, measured in the conveying direction of the powdery material on the conveyor line.

17. The device as defined in claim 3, wherein the device includes a device for determining the flow rate Fl_{PM} of the powdery material.

18. The device as defined in claim 10, wherein at least one of the nozzles is rotatable around the axis of the exit direction of the liquid additive.

19. The device as defined in claim 11, wherein the at least one hydraulic bonding agent is selected from the group consisting of cement, mortar, plaster, silica fume, fly ash, scoria and granulated cinder.

20. The method as defined in claim 14, further comprising:
determining the flow rate Fl_{PM} of the powdery material and/or determining at least one conveying parameter FP_{Fz} of the liquid additive, wherein FP_{Fz} comprises the two parameters flow rate Fl_{Fz} of the liquid additive and conveying pressure P_{Fz} of the liquid additive.

21. The method as defined in claim 15, wherein:
at least one nozzle through which the powdery material is sprayed with at least one liquid additive is connected or disconnected if the conveying pressure P_{Fz} of the liquid additive exceeds a threshold value P_{FZ max}; and/or
at least one nozzle is rotating around the axis of the exit direction of the liquid additive if the conveying pressure P_{Fz} of the liquid additive exceeds a threshold value P_{FZ max}.
